(19) United States
(12) Patent Application Publication
(10) Pub. No.: US 2012/0309398 A1
(43) Pub. Date: Dec. 6, 2012

(54) BASE STATION APPARATUS, COMMUNICATION SYSTEM AND COMMUNICATION METHOD

(75) Inventor: Naotoshi Watanabe, Kawasaki (JP)

(73) Assignee: FUJITSU LIMITED, Kawasaki-shi (JP)

(21) Appl. No.: 13/433,323

(22) Filed: Mar. 29, 2012

(30) Foreign Application Priority Data
May 31, 2011 (JP) 2011-121707

(51) Int. Cl. H04W 36/08; H04W 36/30

(52) U.S. Cl. 455/437; 455/438

(57) ABSTRACT

A base station apparatus including: a reception unit that receives cell information designating a plurality of cells for which reception quality at a mobile station apparatus connected to a serving cell covered by the base station apparatus exceeds a quality; a failure prediction unit that predicts the possibility of occurrence of radio link failure in any of the plurality of cells designated by the cell information; and an execution unit that executes, based on the prediction result of the failure prediction unit, a preparatory procedure with other base station apparatuses respectively covering the plurality of cells designated by the cell information for handover of the mobile station apparatus, when the possibility of occurrence of radio link failure exceeds a reference.

### CROSS-REFERENCE TO RELATED APPLICATIONS

This application is based upon and claims the benefit of priority of the prior Japanese Patent Application No. 2011-121707, filed on May 31, 2011, the entire contents of which are incorporated herein by reference.

### FIELD

Embodiments discussed in the present specification relate to handover technology in a wireless communication system.

### BACKGROUND

A mobile communication system which provides for a reconnection of a mobile station apparatus that encounters a radio link failure (RLF) has been known. With the reconnection procedure, a base station apparatus covering the cell to which the mobile station apparatus is connected uses the base station key it possesses beforehand to carry out security control such as encryption of communication with the mobile station apparatus and protection of message integrity. Thus, in the reconnection procedure, the initial connection procedure for ensuring security of communication with the mobile station apparatus is not executed. As a result, interruption time of service provided to the user of the mobile station apparatus can be reduced. As an example of such reconnection procedure, for example, “RRC (Radio Resource Control) connection re-establishment” in the mobile communication system of LTE (Long term evolution) type defined in 3GPP (3^{rd} Generation Partnership Project) can be mentioned. In the description that follows, a mobile station apparatus and a base station apparatus may sometimes be denoted simply as “mobile station” and “base station”, respectively.

Further, a communication method has been known which includes the step of updating a first key when a mobile station detects a radio link failure after it receives transmittal confirmation information to a handover completion signal, and the step of preventing a first key from being updated when a mobile station UE detects a radio link failure before it receives transmittal confirmation information to a handover completion signal.

Also, a mobile communication method has been known in which a prescribed key is used to perform communication between a mobile station and a wireless base station. This method includes, in the reconnection procedure of a mobile station, the step of acquiring a first key for the wireless base station that manages the reconnection destination cell of the mobile station to generate the prescribed key to be used in communication between the next reconnection destination cell and the mobile station.

Also, a handover method for recovery from radio link failure has been known. In this method, for each target cell determined in a handover determination process, a first message is transmitted from the source base station to a target base station that services the target cell. The first message contains information for acquiring the identifier and authentication data of a wireless device having communication link with the source base station. The authentication data depend on a secret key available to the wireless device and the source base station and on the identity of the target cell. Upon failure of the communication link, a cell is selected at the wireless device, and a reestablishment request message including its identifier and authentication data depending on the secret key and on identity of the selected cell is transmitted. If the selected cell is the target cell serviced by a target base station that received a first message, conformity of the authentication data included in the reestablishment request message with the authentication data obtained from this first message is verified to authorize transfer of this communication link to the selected cell.

Also, a method for providing, to a mobile terminal, information (pointer) required to acquire system information on another cell beforehand has been known. This includes transmission of at least one pointer to related system information of another cell to the mobile terminal by a base station controlling the cell in which the mobile terminal is located at present. The mobile terminal can know from the current base station when and where related system information will be transmitted in the future cell, before it is connected to the next cell while a hard handover procedure is being executed, or before it is attached to the next cell while cell re-selection procedure is being executed. Thus, no MIB on next cell is required to acquire related system information, and time and resource can be saved. An example of the pointer points to system information of the next cell required for mobility procedure such as handover or cell re-selection.

### SUMMARY

According to an aspect of the apparatus, a base station apparatus is provided. The base station apparatus includes a reception unit that receives cell information designating a plurality of cells in which reception quality at the mobile station apparatus connected to a serving cell covered by the base station apparatus exceeds a prescribed quality, a failure prediction unit that predicts possibility of occurrence of radio link failure in any of the plurality of cells designated by the cell information, and an execution unit that executes preparatory procedure with other base station apparatuses respectively covering the plurality of cells designated by the cell information for handover of a mobile station apparatus, when based on the prediction result of the failure prediction unit, the possibility of occurrence of radio link failure exceeds a reference.

According to another aspect of the apparatus, a communication system including a base station apparatus and a mobile station apparatus is provided. The mobile station apparatus includes a reception quality measurement unit that measures reception quality of signal from a cell, and a cell information transmission unit that transmits cell information designating a plurality of cells for which reception quality exceeding a prescribed quality is measured, to the base station apparatus covering the serving cells of the mobile station apparatus. The base station apparatus includes a reception unit that receives cell information from the mobile station apparatus connected to cells covered by the base station apparatus, a failure prediction unit that predicts possibility of occurrence of radio link failure in any of the plurality of cells designated by the cell information, and an execution unit that executes preparatory procedure with other base station apparatuses respectively covering the plurality of cells designated by the cell information for handover of a mobile station apparatus, when based on the prediction result of the failure prediction unit, the possibility of occurrence of radio link failure exceeds a reference.

According to an aspect of the method, a communication method including: measuring reception quality of signal received by a mobile station apparatus from cells other than the serving cell, specifying a plurality of cells for which the measured reception quality exceeds a prescribed quality, predicting possibility of occurrence of radio link failure in any of the specified plurality of cells, and executing a preparatory procedure with other base station apparatuses respectively covering the plurality of cells for handover of the mobile station apparatus from the serving cell, when the possibility of occurrence of radio link failure exceeds a reference is provided.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a view depicting the exemplary overall construction of the communication system;

FIG. 2A is a view for illustrating a first example of the handover processing;

FIG. 2B is a view for illustrating a first example of the handover processing;

FIG. 2C is a view for illustrating a first example of the handover processing;

FIG. 3A is a view for illustrating a second example of the handover processing;

FIG. 3B is a view for illustrating a second example of the handover processing;

FIG. 4 is a view depicting an example of hardware construction of a mobile station apparatus;

FIG. 5 is a view depicting an exemplary construction of a mobile station apparatus;

FIG. 6 is a view depicting an example of hardware construction of a base station apparatus;

FIG. 7 is a view depicting an exemplary construction of a base station apparatus;

FIG. 8 is a view depicting an example of processing carried out by a mobile station apparatus;

FIG. 9 is a view for illustrating a first example of processing carried out by a base station apparatus;

FIG. 10 is a view for illustrating other handover processing;

FIG. 11 is a view for illustrating a second example of processing carried out by a base station apparatus;

FIG. 12A is a view for illustrating the handover processing according to FIG. 11; and

FIG. 12B is a view for illustrating the handover processing according to FIG. 11.

### DESCRIPTION OF EMBODIMENTS

### <1. Construction of Communication System>

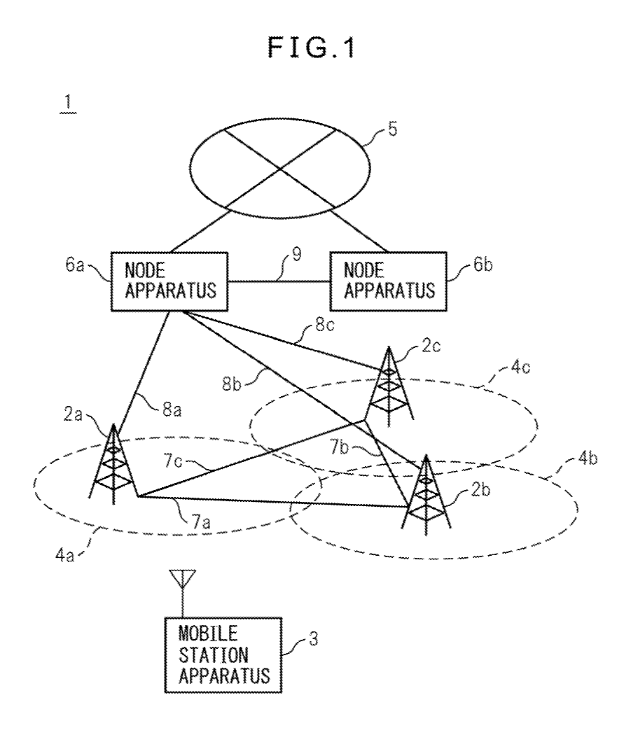

The embodiment will be described with reference to appended drawings. FIG. 1 is a view depicting the exemplary overall construction of the communication system. The communication system 1 includes a plurality of base stations including base stations 2a, 2b, 2c,—and a mobile station 3. Reference numerals 4a˜4c respectively denote schematically ranges of cells covered by the base stations 2a˜2c. In description that follows, the base stations 2a, 2b, 2c—may be sometimes collectively denoted as “base station 2”. Also, the cells 4a, 4b, 4c—may be sometimes collectively denoted as “cell 4”.

The communication system 1 further includes a wired network 5 connecting the base stations 2 and the public network, and node apparatuses 6a and 6b of the wired network 5. Between the base stations 2, inter-base station logic connections are provided. In the illustrated example, inter-base station logic connections 7a, 7b and 7c are respectively provided between base stations 2a and 2b, base stations 2b and 2c, base stations 2c and 2a.

Also, between base stations 2a, 2b and 2c and the node apparatus 6a, there are provided inter-base station-node logic connections 8a, 8b and 8c. Further, between the node apparatuses 6a and 6b, there is provided an inter-node logic connection 9. In the description that follows, the node apparatuses 6a and 6b may be sometimes collectively denoted as “node apparatus 6”. Also, inter-base station-node logic connection, and inter-base station-node logic connection and inter-node logic connection may be sometimes collectively denoted as “logic connection”. Further, logic connections 7a˜7c and 8a˜8c may be sometimes collectively denoted as “logic connection 7” and “logic connection 8”, respectively.

For example, the node apparatus 6 may be an integrated node of MME (Mobility Management Entity)/S-GW (Serving Gateway)/PDN-GW (Packet Data Network-Gateway) of mobile communication system EPC (Evolved Packet Core) containing wireless access network of LTE type. The logic connections 7, 8 and 9 may be X2 interface, S1 interface and S10 interface, respectively. The wired network 5 may be an Internet, or an enterprise network.

### <2. Description of Handover Processing>

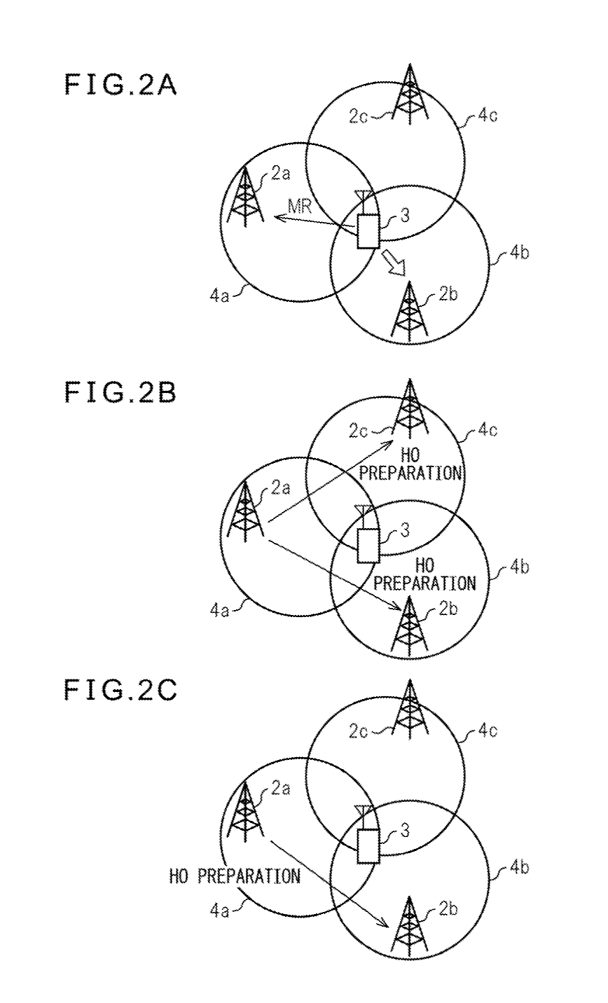

Next, an example of handover processing of a mobile station in the communication system 1 will be described below. In FIG. 2A, the mobile station 3 measures reception quality of signal from the cell 4 at the cell end of the serving cell 4a. When the reception quality of signal from the base station 2b covering the cell 4b exceeds a prescribed quality value Qm, the mobile station 3 transmits the measurement report to the base station 2a of the serving cell 4a. The prescribed quality value Qm may be, for example, the reception quality satisfying handover execution condition to the cell 4b by the mobile station 3. In appended drawings, measurement report is denoted as “MR”. In the present specification, unless otherwise indicated, the serving cell of the mobile station 3 is supposed to be the cell 4a covered by the base station 2a in the following description.

The measurement report transmitted by the mobile station 3 includes, in addition to the reception quality information of signal from the base station 2b covering cell 4b, the reception quality information of signal from the base station 2c covering cell 4c for which reception quality exceeding a prescribed quality Qr was measured by the mobile station 3. The prescribed quality Qr is the reception quality that can be received by the mobile station 3 to determine whether or not reception quality of signal from the base station 2c is to be included in the measurement report. The prescribed quality Qr, may be determined to be lower than the prescribed value Qm, which is the reception quality for the mobile station 3 to determine whether or not measurement report is to be transmitted, i.e., such that the reception quality of signal from the base station 2b exceeding the prescribed quality value Qm exceeds the prescribed quality Qr. The base station 2a receives the measurement report transmitted from the mobile station 3.

The base station 2a predicts possibility of occurrence of RLF produced in the mobile station 3 at the cell 4b. When the possibility of occurrence of RLF exceeds the prescribed reference, as depicted in FIG. 2B, the base station 2a executes handover preparatory procedure to both base station 2b covering cell 4b and base station 2c covering cell 4c. In appended drawings, handover is denoted as “HO”.

A handover preparatory procedure is a preparatory procedure for handover from the base station covering the serving cell to other base station. For example, a handover preparatory procedure may be a procedure for one base station to transmit information which the base station 2 covering the cell to be reconnected needs to hold in order for the reconnection procedure by the mobile station 3 to be successful to other base station. For example, when key management protocol is not implemented in reconnection procedure, and thus, the mobile station 3 can be reconnected only to the base station 2 possessing the base station key, the handover preparatory procedure may be a procedure for transmitting the base station key or key information for specifying it. Further, when the base station 2 to be reconnected needs to hold context information of the mobile station 3 in order for the reconnection procedure to be successful, the handover preparatory procedure may be a procedure for transmitting the context information of the mobile station 3. As an example of such handover preparatory procedure, “Handover Preparation” in the communication system of LTE (Long-term Evolution) type can be mentioned. In description that follows, “information which the base station 2 covering the cell to be reconnected needs to hold in order for the reconnection procedure by the mobile station 3 to be successful” may be sometimes denoted as “information necessary for reconnection procedure”.

On the other hand, when possibility of occurrence of RLF does not exceed the prescribed reference, the base station 2a executes the handover preparatory procedure only to the base station 2b covering the cell 4b as depicted in FIG. 2C.

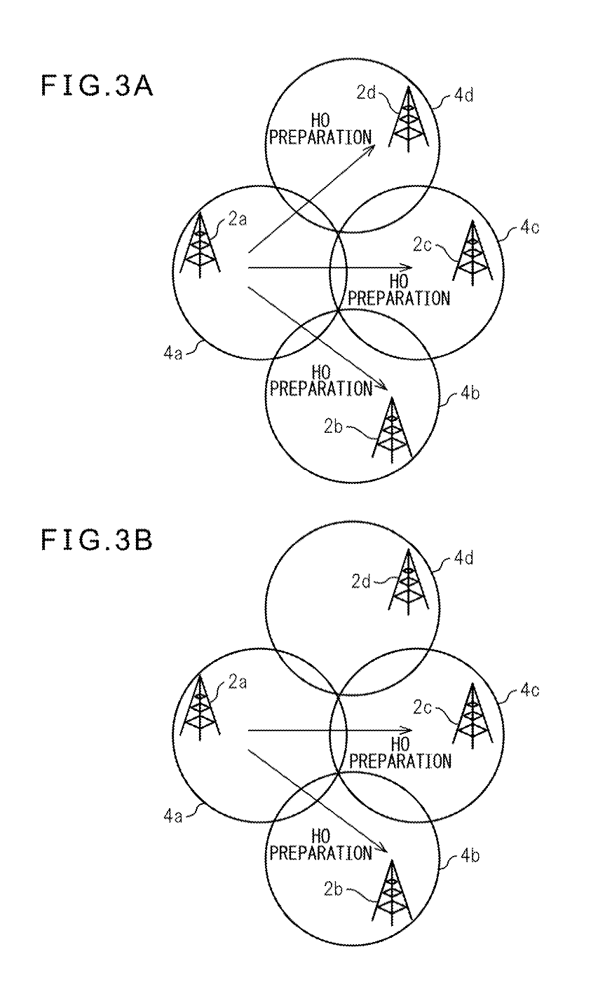

FIG. 3A is a view for illustrating another example of handover processing. The measurement report transmitted by the mobile station 3 may include, in addition to the reception quality information of signal from the base station 2b, the reception quality information of signal from two or more base stations for which the reception quality exceeding the prescribed quality Qr was measured by the mobile station 3. In the example of FIG. 3A, the measurement report includes the reception quality information from the base stations 2c and 2d for which the reception quality exceeding the prescribed quality Qr was measured by the mobile station 3.

When the possibility of occurrence of RLF in the cell 4b exceeds the prescribed reference, the base station 2a may execute handover preparatory procedure to two or more base stations 2 among the base station 2 for which reception quality information is included in the measurement report, in addition to the base station 2b covering the cell 4b. In the example of FIG. 3A, the base station 2a executes handover preparatory procedure to base stations 2b˜2d.

In one embodiment, only when a possibility of occurrence of RLF in the cells 4b and 4d exceeds the prescribed reference, the handover preparatory procedure is executed to the base station 2d. When possibility of occurrence of RLF exceeds the prescribed reference only in the cells 4b, the handover preparatory procedure needs not be executed to the base station 2d. Such an example is depicted in FIG. 3B.

In the handover processing described above, when possibility of occurrence of RLF in cell 4b as the handover target candidate is higher than the reference, a preliminary handover preparatory procedure is executed to other cells. Therefore, even if RLF occurs in the cell 4b as the handover target candidate, the mobile station 3 can attempt reconnection procedure to other cells, so that, at the time of handover, even when RLF is likely to occur, failure of reconnection procedure can be reduced.

When, for example, the possibility of occurrence of RLF in the cell 4b as a handover target candidate is equal to or lower than the reference, the handover preparatory procedure is not executed to other cells. When possibility of occurrence of RLF is determined for a plurality of cells and a cell with possibility of occurrence of RLF equal to or lower than the reference is found, number of cells for which handover preparatory procedure is executed is not increased. Thus, increase of target cells of handover preparatory procedure can be avoided and transmission amount of control signal between base stations can be reduced.

### <3. Embodiment of Mobile Station>

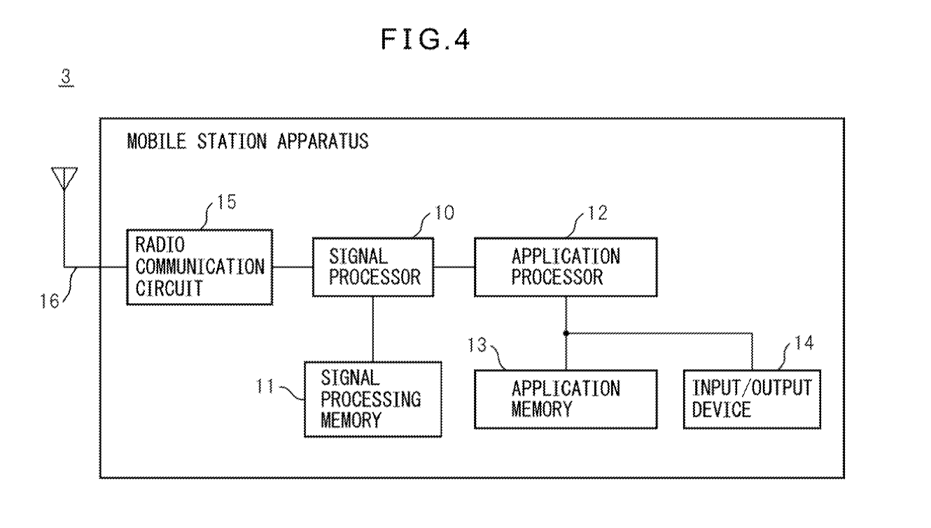

Next, each of the constituents of the communication system 1 will be described below. FIG. 4 is a view illustrating an example of hardware construction of a mobile station 3. The mobile station 3 includes a signal processor 10, a signal processing memory 11, an application processor 12, an application memory 13, an input/output device 14, a radio communication circuit 15 and an antenna 16. The hardware construction depicted in FIG. 4 is merely an example of hardware construction for realizing a mobile station 3. Any other hardware construction may be adopted as long as the processing described below in this specification can be carried out.

The radio communication circuit 15 carries out digital-to-analog conversion, analog-to-digital conversion, frequency conversion, signal amplification, and filtering of radio signal transmitted and received via the antenna 16 between the mobile station 3 and a base station 2. The application processor 12 causes user's application to be operated, and carries out generation and extraction of user data transmitted and received between the mobile station 3 and a base station 2, and information processing of user data. In the application memory 13, application programs executed by the application processor 12, and information and temporary data used in the execution are stored. The input/output device 14 carries out reception processing of the input operation of user data by users, and the output of user data to users.

The signal processor 10 carries out baseband signal processing other than the processing carried out by the application processor 12. In the signal processing memory 11, the signal processing program to be executed by the signal processor 10 and data to be used for the execution are stored.

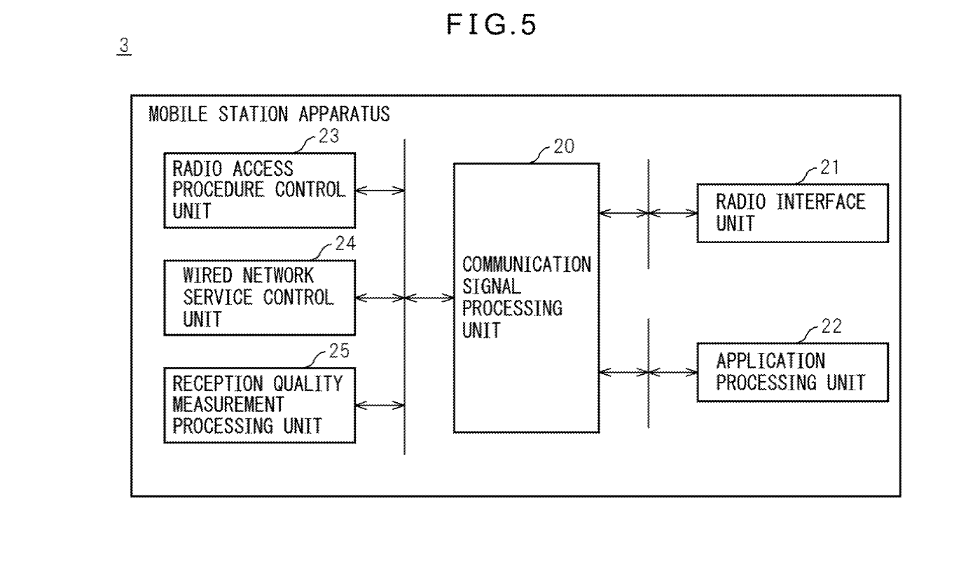

FIG. 5 is a view depicting the exemplary construction of a mobile station 3. The mobile station 3 includes a communication signal processing unit 20, a radio interface unit 21, an application processing unit 22, a radio access service control unit 23, a wired network service control unit 24, and a reception quality measurement processing unit 25.

Signal processing in the radio interface unit 21 is carried out by the radio communication circuit 15 and the signal processor 10. Information processing in the application processing unit 22 is carried out by the application processor 12. Signal processing in other constituents is carried out by the signal processor 10 executing the signal processing program stored in the signal processing memory 11. FIG. 5 depicts mainly the functions related to the description that follows. Therefore, the mobile station 3 may include constituents other than the depicted constituents.

Next, operation of each of the constituents 20˜25 will be described. The communication signal processing unit 20 carries out processing on the setting of data and processing on data transfer protocol based on setting information of communication channel or bearer. Also, the communication signal processing unit 20 recognizes signaling information directed to the mobile station 3, such as radio access procedure message, etc., and transmits and receives data to and from other constituents processing this signaling information.

The radio interface unit 21 carries out the physical layer protocol and data link layer protocol proper to the communication system 1, and transmits and receives data between a communication apparatus external to the mobile station 3 and the communication signal processing unit 20. The application processing unit 22 causes an application used by a user of the mobile station 3 to be operated. The application processing unit 22 becomes a transmitter and receiver of data transmitted and received via the network to and from an opposing communication node.

The radio access control unit 23 carries out control signaling to and from the base stations 2 such as RRC (Radio Resource Control), and carries out control for setting and release of communication channel of wireless section. The wired network service control unit 24 carries out control signaling with a network entity on the side of wired network 5, and carries out control for setting and release of communication channel of sections other than wireless section. The reception quality measurement processing unit 25 measures reception quality of signal from cells and generates the measurement report.

As regards the processing disclosed in this specification, the radio access procedure control unit 23 receives, from the base station 2a, the above-described prescribed value Qm for determining whether or not the mobile station 3 transmits the measurement report, and the above-described prescribed quality Qr for determining whether or not the reception quality of signal from the base stations 2 is included in the measurement report.

As described above, the prescribed value Qm may be, for example, the reception quality satisfying the condition for the mobile station 3 to execute handover to a cell. In the description that follows, an embodiment will be described in which the mobile station transmits the measurement report when the handover execution condition for the mobile station to execute handover to a cell 4b is satisfied. When the reception quality of signal from the cell 4b exceeds the prescribed value Qm, the cell 4b may be denoted as “handover target candidate cell”. The apparatus, system and method disclosed in this specification is not limited to this embodiment. Values based on various criteria may be adopted as the prescribed value Qm.

Also, a cell 4 for which reception quality exceeding the prescribed quality Qr was measured, other than the handover target candidate cell 4b, may be denoted as “reserve candidate cell”.

The radio access procedure control unit 23 may receive, from the base station 2a, the reserve candidate report setting which instructs reception quality information of the reserve candidate cell to be included in the measurement report. The radio access procedure control unit 23 sets the handover execution condition, the prescribed quality Qr, and the reserve candidate report setting in the reception quality measurement processing unit 25.

The reception quality measurement processing unit 25 measures the reception quality of signal from the cells 4, and when there is a handover target candidate cell 4b satisfying the handover execution condition, generates measurement report including the reception quality information of the handover target candidate cell 4b. The reception quality information included in the measurement report may include identifier of the handover target candidate cell 4b and information indicating reception quality of the handover target candidate cell 4b.

When there is reserve candidate report setting, the reception quality measurement processing unit 25 specifies the reserve candidate cell 4 with reception quality exceeding the prescribed quality Qr, and include the reception quality information of the reserve candidate cell 4 into the measurement report. The reception quality information included in the measurement report may include identifier of the reserve candidate cell 4b and information indicating reception quality of the reserve candidate cell 4b.

The reception quality measurement processing unit 25 requests transmission of the measurement report by the radio access procedure control unit 23. The radio access procedure control unit 23 transmits the measurement report to the base station 2a. The reception quality measurement processing unit 25 is an example of the reception quality measurement unit. The radio access procedure control unit 23 is an example of the cell information transmission unit.

### <4. Embodiment of the Base Station>

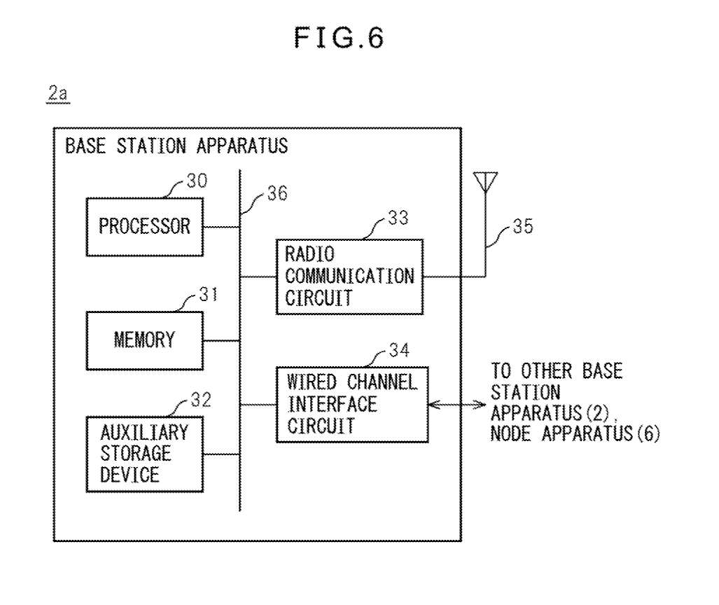

Next, the base station 2 will be described. FIG. 6 is a view depicting an example of the hardware construction of the base station 2a. Other base stations 2b, 2c,—have the same construction. The base station 2a includes a processor 30, a memory 31, an auxiliary storage device 32, a radio communication circuit 33, a wired channel interface circuit 34, and an antenna 35. The processor 30, memory 31, auxiliary storage device 32, radio communication circuit 33, wired channel interface circuit 34 are connected by bus 36. The hardware construction depicted in FIG. 6 is merely one hardware construction for realizing the base station 2a. Any other hardware construction may be adopted as long as processing described below in this specification can be carried out.

The radio communication circuit 33 carries out digital-to-analog conversion, analog-to-digital conversion, frequency conversion, signal amplification, and filtering of radio signal transmitted and received via the antenna 35 between a mobile station 3 and the base station 2a. The wired channel interface circuit 34 carries out signal processing of data transmitted and received between other base stations 2b, 2c,—and the node apparatus 6.

The processor 30 carries out control signaling and routing of data, etc. In the auxiliary storage device 32, the signal processing program executed by the processor 30 and information used for the execution are stored. In the data memory 31, the signal processing program being executed and temporary data are stored.

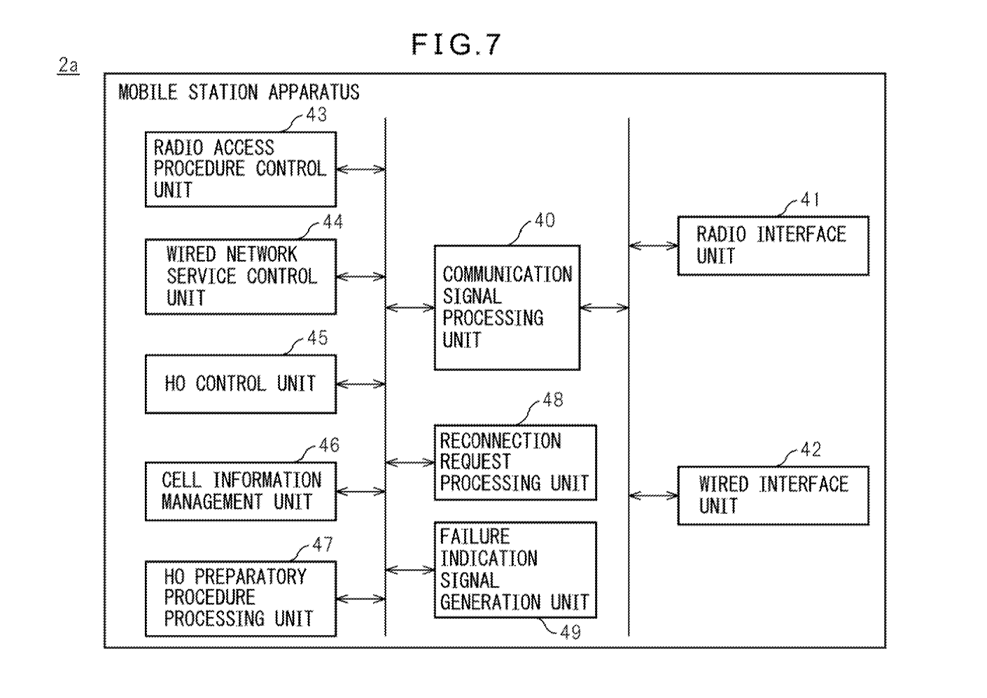

FIG. 7 is a view depicting an exemplary construction of the base station 2a. Other base stations 2b, 2c,—have the same construction. The base station 2a includes a communication signal processing unit 40, a radio interface unit 41, a wired interface unit 42, a radio access procedure control unit 43, a wired network service control unit 44, a handover control unit 45, a cell information management unit 46, a handover preparatory procedure processing unit 47, a reconnection request processing unit 48, and a failure indication signal generating unit 49.

Signal processing by the radio interface unit 41 is carried out by the radio communication circuit 33 and the processor 30. Signal processing by the wired interface unit 42 is carried out by the wired channel interface circuit 34 and the processor 30. Signal processing by other constituent is carried out by the processor 30 executing the signal processing program stored in the auxiliary storage device 32. FIG. 7 depicts mainly the functions related to the following description. Therefore, the base station 2a may include constituents other than the constituents depicted in the drawing.

Next, operation of each of the constituents 40˜49 will be described. The communication signal processing unit 40 carries out processing on routing of data and processing of data transfer protocol, based on setting information of communication channels or bearer. Also, the communication signal processing unit 40 recognizes signaling information directed to the base station 2a such as radio access procedure message, etc., and transmits and receives data to and from other constituents processing this signaling information.

The radio interface unit 41 and the wired interface 42 execute the physical layer protocol and the data link layer protocol proper to the communication system 1, and transmit and receive data between a communication apparatus external to the base station 2a and the communication signal processing unit 40. The radio interface unit 41 transmits and receives data to and from the mobile station 3. The wired interface unit 42 executes information processing and signal processing for communication procedure implemented in the logic connection 7 transmitting and receiving data to and from other base stations 2b, 2c,—and the logic connection 8 transmitting and receiving data to and from the node apparatuses 6.

The radio access procedure control unit 43 carries out control signaling to and from the mobile station 3, and carries out control for setting and release of communication channel of wireless section. The wired network service control unit 44 carries out control signaling to and from the network entity on the side of wired network 5, and carries out control for setting and release of communication channel of section other than the wireless section.

The handover control unit 45 sets handover execution condition. Based on the content of the measurement report received from the mobile station 3, the handover control unit 45 determines whether or not handover is to be executed, and selects the handover target cell. The cell information management unit 46 manages contiguity information representing the contiguity between cells covered by the base station 2a and the contiguity between cells 4 covered by the base station 2a and cells 4 covered by other base station 2a.

For example, the contiguity information may be a table information having table entry storing each of the cells 4 covered by the base station 2a and other cells 4a adjoining each cell 4. For example, the cell information management unit 46 may generate the table entry by obtaining information on contiguity between cells 4 from other network entity forming the communication system 1 arranged in the wired network 5. Also, for example, the cell information management unit 46 may generate the table entry based on information obtained in control signaling between the mobile station 3 and the base station 2a and/or control signaling between the network entity on the side of the wired network 5 and the base station 2a.

The handover preparatory procedure processing unit 47 predicts the possibility of occurrence of RLF in the cells 4 reported in the measurement report. Based on this prediction result, the handover preparatory procedure processing unit 47 requests, to the wired network service control unit 44, the execution of the handover preparatory procedure for the cell 4 reported in the measurement report.

The reconnection request processing unit 48 executes, in response to reconnection request received from the mobile station 3 in which RLF occurs, the reconnection processing for connecting this mobile station 3 to the cell 4a covered by the base station 2a. The failure indication signal generating unit 49 generates RLF instruction signal informing the reconnection request received from the mobile station 3 to the base station 2 covering the cell 4 where RLF occurred in the connection to the mobile station 3. The failure indication signal generating unit 49 may determine which cell is the cell 4 connected to the mobile station 3 based on the identifier of the cell designated in the reconnection request. As an example of RLF instruction signal, “RLF indication message” in the mobile communication system of LTE type can be mentioned, for example.

Regarding the processing disclosed in this specification, the handover control unit 45 determines the handover execution condition and the prescribed quality Qr. The handover control unit 45 requests to the radio access procedure control unit 23 to transmit the handover execution condition and the prescribed quality Qr to the mobile station 3 connected to the serving cell 4a covered by the base station 2a. Also, the handover control unit 45 may request to the radio access procedure control unit 43 to transmit the reserve candidate report setting to the mobile station 3. Based on the content of the measurement report received from the mobile station 3, the handover control unit 45 determines whether or not handover of the mobile station 3 to the handover target candidate cell 4b is to be executed.

When the reception quality information of the reserve candidate cell 4c is included in the measurement report, the handover preparatory procedure processing unit 47 predicts the possibility of occurrence of RLF in the handover target candidate cell 4b. For example, the handover preparatory procedure processing unit 47 may predict the possibility of occurrence of RLF in the target cell 4 based on frequency of transmission of RLF instruction signal transmitted in the past from the serving cell 4a of the mobile station 3 to the target cell 4. Also, the handover preparatory procedure processing unit 47 may predict the possibility of occurrence of RLF in the target cell 4 based on frequency of occurrence of reconnection request occurring in the past from the target cell 4 to the serving cell 4a.

When the possibility of occurrence of RLF in the handover target cell 4b exceeds the prescribed reference, the handover preparatory procedure processing unit 47 requests, to the wired network service control unit 44, the execution of the handover preparatory procedure to the handover target candidate cell 4b and reserve candidate cell 4c. If the possibility of occurrence of RLF in the handover target candidate cell 4b does not exceed the prescribed reference, the handover preparatory procedure processing unit 47 requests, to the wired network service control unit 44, the execution of the handover preparatory procedure only to the handover target candidate cell 4b.

The wired network service control unit 44 executes the handover preparatory procedure to the cell 4 requested by the handover preparatory procedure processing unit 47. In the handover preparatory procedure, the wired network service control unit 44 transmits handover request signal via the logic connection 7 to the base station 2 of the cell 4 to which the handover preparatory procedure is to be executed. The handover request signal is the signal that transmits necessary information for reconnection procedure by the mobile station 3 between base stations.

As an example of the handover request signal, for example, “Handover Request message” in the mobile communication system of LTE type can be mentioned. Depending on positional relation between the base station 2a and the base station 2 covering the cell 4 that executes the handover preparatory procedure, there may be no logic connection 7 between base stations 2. In such case, the wired network service control unit 44 transmits necessary information for reconnection procedure to the node apparatus 6 via the logic connection 8. The information necessary for reconnection procedure is transmitted via the logic connection 8, the node apparatus 6 and the logic connection 9 to the base station 2 covering the cell 4 that executes the handover preparatory procedure.

The radio access procedure control unit 43 is an example of the reception unit. The handover preparatory procedure processing unit 47 is an example of the failure prediction unit. The handover preparatory procedure processing unit 47 and the radio access procedure control unit 43 is an example of the transmission unit. The failure indication signal generating unit 49 and the radio access procedure control unit 43 is an example of the failure indication signal transmission unit. The handover control unit 45 is an example of the handover determination unit. The handover control unit 45 and the radio access procedure control unit 43 is an example of the condition notification unit.

### <5. Description of Processing in Various Device>

<5.1 First Embodiment>

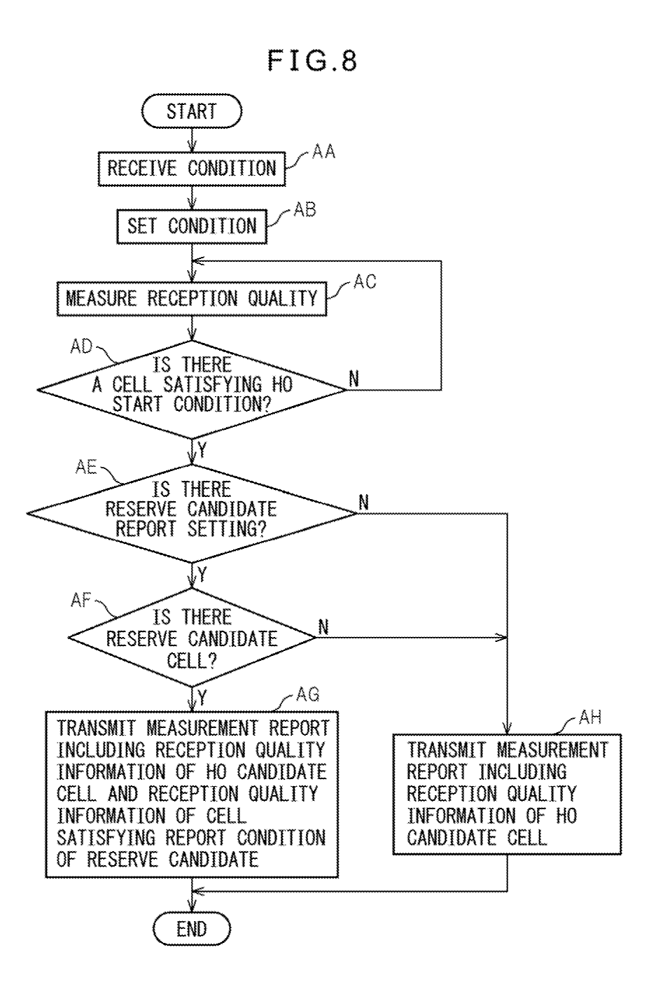

Next, the processing in the mobile station 3 and the base station 2 will be described below. FIG. 8 is a view illustrating an example of processing in the mobile station 3. A series of processing described below may be construed as a method including plural steps. In such a case, “operation” may be rewritten as “step”.

In operation AA, the radio access procedure control unit 23 receives the prescribed value Qm, the prescribed quality Qr, and the reserve candidate report setting from the base station 2a. In operation AB, the radio access procedure control unit 23 sets the handover execution condition, the prescribed quality Qr and the reserve candidate report setting in the reception quality measurement processing unit 25.

In operation AC, the reception quality measurement processing unit 25 measures the reception quality of signal from the cell 4. In operation AD, the reception quality measurement processing unit 25 determines whether or not there is a handover target candidate cell 4 satisfying the handover execution condition. If there is a handover target candidate cell 4b (operation AD: Y), the processing proceeds to operation AE. If there is no handover target candidate cell 4b (operation AD: N), the processing returns to operation AC.

In operation AE, the reception quality measurement processing unit 25 determines whether or not the reserve candidate report setting has been set by the radio access procedure control unit 23. If the reserve candidate report setting has been set (operation AE: Y), the processing proceeds to operation AF. If the reserve candidate report setting has not been set (operation AE: N), the processing proceeds to operation AH.

In operation AF, the reception quality measurement processing unit 25 determines whether or not there is a reserve candidate cell 4c for which reception quality in the mobile station 3 exceeds the prescribed quality Qr. If there is a reserve candidate cell 4c (operation AF: Y), the processing proceeds to operation AG. If there is no reserve candidate cell 4c (operation AF: N), the processing proceeds to operation AH.

In operation AG, the reception quality measurement processing unit 25 generates the measurement report including the reception quality information of the handover target candidate cell 4b and the reserve candidate cell 4c. The radio access procedure control unit 23 transmits the measurement report to the base station 2a covering the serving cell 4a. Thereafter, the processing is terminated.

In operation AH, the reception quality measurement processing unit 25 generates the measurement report including only the reception quality information of the handover target candidate cell 4b. The radio access procedure control unit 23 transmits the measurement report to the base station 2a covering the serving cell 4a. Thereafter, the processing is terminated.

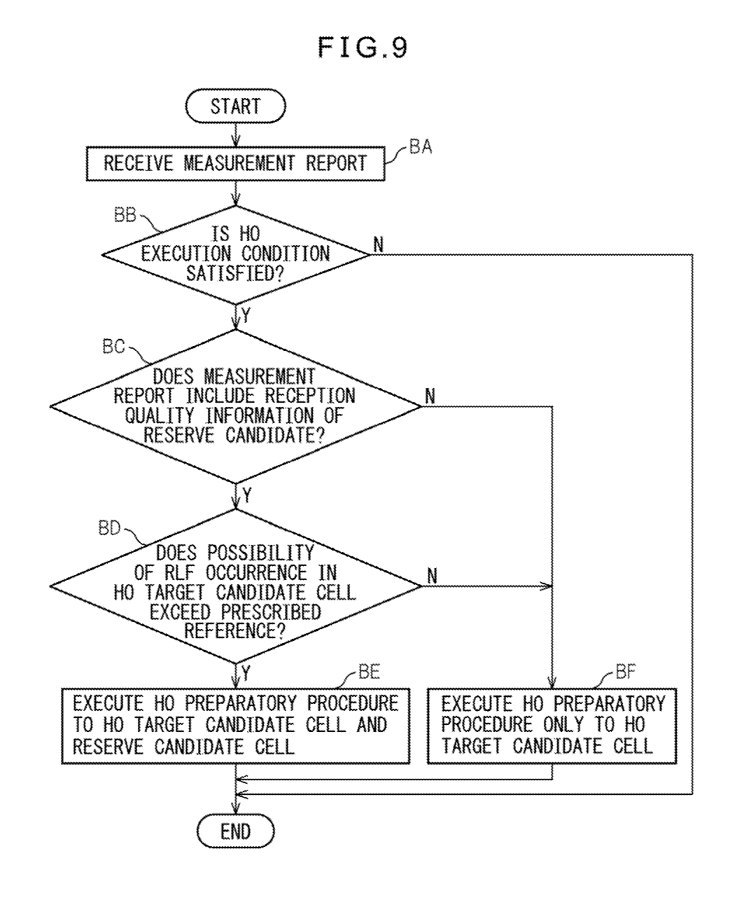

FIG. 9 is a view useful for illustrating a first example of the processing by the base station 2. A series of processing described below may be construed as a method including plural steps. In such a case, “operation” may be rewritten as “step”. In operation BA, the radio access procedure control unit 43 receives the measurement report from the mobile station 3.

In operation BB, the handover control unit 45 determines whether or not the reception quality of the handover target candidate cell 4b reported in the measurement report received from the mobile station 3 satisfies the handover execution condition. If the handover execution condition is satisfied (operation BB: Y), the processing proceeds to operation BC. If the handover execution condition is not satisfied (operation BB: N), the processing is terminated.

In operation BC, the handover preparatory procedure processing unit 47 determines whether or not the measurement report includes the reception quality information of the reserve candidate cell 4c. If the measurement report includes the reception quality information of the reserve candidate cell 4c (operation BC: Y), the processing proceeds to operation BD. If the measurement report does not include the reception quality information of the reserve candidate cell 4c (operation BC: N), the processing proceeds to operation BF.

In operation BD, the handover preparatory procedure processing unit 47 predicts the possibility of occurrence of RLF in the handover target candidate cell 4b. If the possibility of occurrence of RLF exceeds the prescribed reference (operation BD: Y), the processing proceeds to operation BE. If the possibility of occurrence of RLF does not exceed the prescribed reference (operation BD: N), the processing proceeds to operation BF.

In operation BE, the handover preparatory procedure processing unit 47 requests, to the wired network service control unit 44, the execution of the handover preparatory procedure to the handover target candidate cell 4b and the reserve candidate cell 4c. The wired network service control unit 44 executes the handover preparatory procedure. Thereafter, the processing is terminated. In operation BF, the handover preparatory procedure processing unit 47 requests, to the wired network service control unit 44, the execution of the handover preparatory procedure only to the handover target candidate cell 4b. Thereafter, the processing is terminated.

In accordance with this embodiment, if the possibility of occurrence of RLF in the handover target candidate cell 4b exceeds the reference, the handover preparatory procedure is executed also to the reserve candidate cell 4c. Therefore, even if RLF occurs in the cell 4b at the time of handover, the reconnection procedure can also be executed to the cell 4c, so that possibility of failure of the reconnection procedure can be reduced.

When the possibility of occurrence of RLF in the handover target candidate cell 4b does not exceed the reference, the handover preparatory procedure to the reserve candidate cell 4c is not executed. Thus, increase of the number of target cells of handover preparatory procedure can be avoided, and transmission of control signal between base stations can be reduced.

In operation BD described above, the handover preparatory procedure processing unit 47 determines whether or not the handover preparatory procedure to the reserve candidate cell 4c is to be executed based on the possibility of occurrence of RLF in the handover target candidate cell 4b.

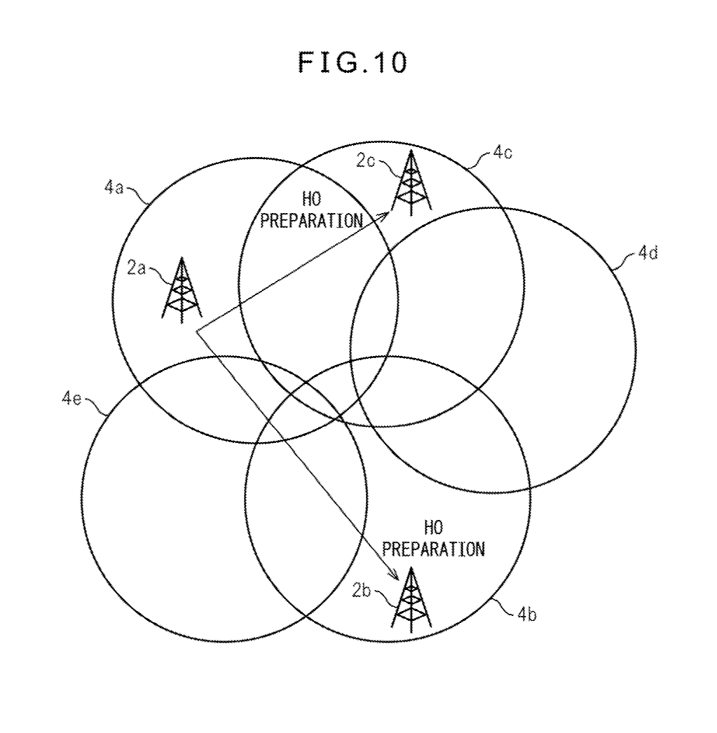

FIG. 10 is a view for illustrating the handover processing in other example. In other embodiment, the handover preparatory procedure processing unit 47 may predict the possibility of occurrence of RLF not only in the handover target candidate cell 4b but also in the adjoining cells 4d and 4e common to the serving cell 4a and the handover target candidate cell 4b. The handover preparatory procedure processing unit 47 may determine whether or not the handover preparatory procedure to the reserve candidate cell 4c is to be executed based on the possibility of occurrence of RLF in the handover target candidate cell 4b and the adjoining cells 4d, 4e.

In this example, the possibility of occurrence of RLF is predicted in the adjoining cells 4d and 4e in addition to the handover target candidate cell 4b. Therefore, the possibility of occurrence of RLF is predicted in the handover target candidate cell 4b can be predicted more accurately.
<5.2 Second Embodiment>

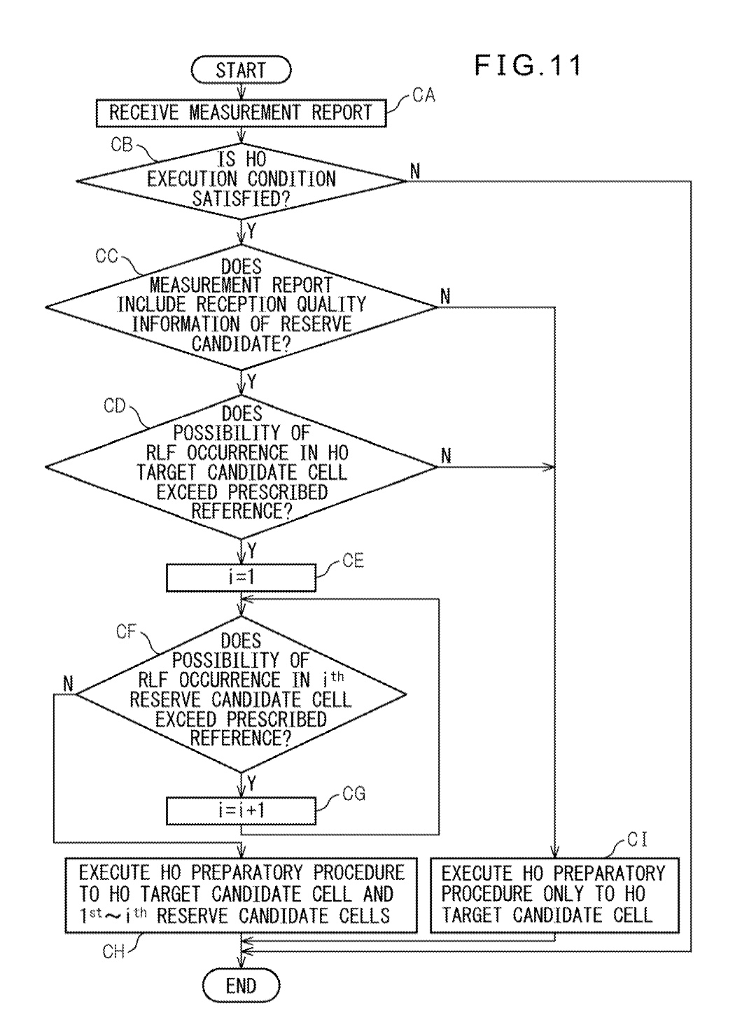

Next, other embodiment of the processing by the base station 2 will be described. FIG. 11 is a view for illustrating a second example of the processing by the base station 2. A series of processing described below may be construed as a method including plural steps. In such a case, “operation” may be rewritten as “step”. In operation CA, the radio access procedure control unit 43 receives the measurement report from the mobile station 3.

In operation CB, the handover control unit 45 determines whether or not the reception quality of the handover target candidate cell 4b satisfies the handover execution condition. If the handover execution condition is satisfied (operation CB: Y), the processing proceeds to operation CC. If the handover execution condition is not satisfied (operation CB: N), the processing is terminated.

In operation CC, the handover preparatory procedure processing unit 47 determines whether or not the measurement report includes the reception quality information of the reserve candidate cell 4. If the measurement report includes the reception quality information of the reserve candidate cell 4 (operation CC: Y), the processing proceeds to operation CD. If the measurement report does not include the reception quality information of the reserve candidate cell 4 (operation CC: N), the processing proceeds to operation CI.

In operation CD, the handover preparatory procedure processing unit 47 predicts the possibility of occurrence of RLF in the reserve candidate cell 4. If the possibility of occurrence of RLF exceeds the prescribed reference (operation CD: Y), the processing proceeds to operation CE. If the possibility of occurrence of RLF does not exceed the prescribed reference (operation CD: N), the processing proceeds to operation CI.

In operation CE, the handover preparatory procedure processing unit 47 substitutes the value “1” into the variable i. In operation CF, the handover preparatory procedure processing unit 47 predicts possibility of occurrence of RLF in the reserve candidate cell 4 with i^{th} reception quality among the reserve candidate cells 4 with the reception quality information included in the measurement report. If the possibility of occurrence of RLF exceeds the prescribed reference (operation CF: Y), the processing proceeds to operation CG. If the possibility of occurrence of RLF does not exceed the prescribed reference (operation CF: N), the processing proceeds to operation CH. In operation CG, the handover preparatory procedure processing unit 47 increases the value of the variable I by “1”. After operation CG, the processing returns to operation CF.

In operation CH, the handover preparatory procedure processing unit 47 requests to the wired network service control unit 44 to execute the handover preparatory procedure to the handover target candidate cell 4b and to the reserve candidate cells 4c of the 1^{st} to i^{th} reception quality. The wired network service control unit 44 executes the handover preparatory procedure. Thereafter, the processing is terminated.

In operation CI, the handover preparatory procedure processing unit 47 requests the wired network service control unit 44 to execute the handover preparatory procedure only to the handover target candidate cell 4b. Thereafter, the processing is terminated.

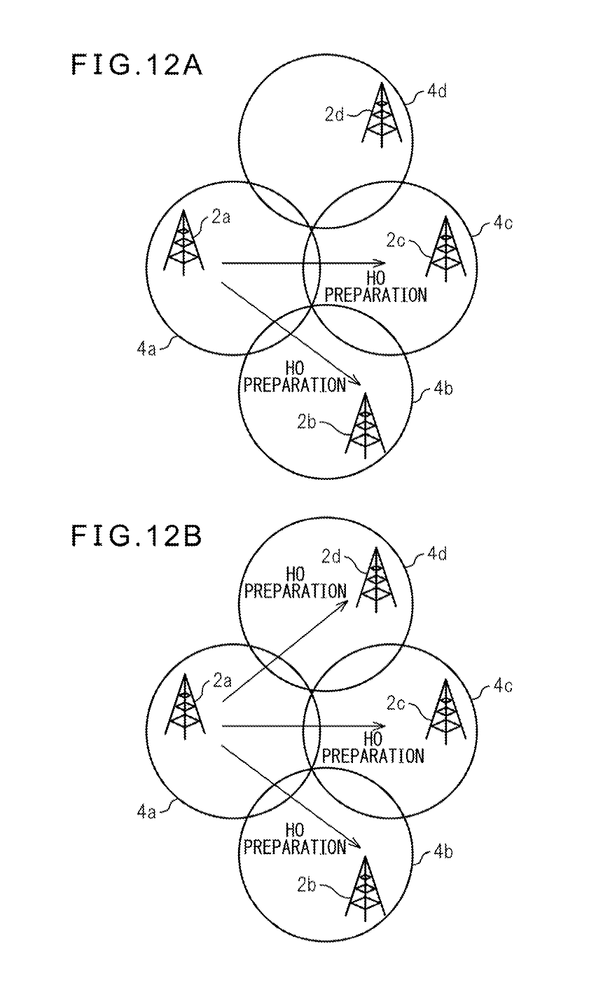

FIG. 12A and FIG. 12B are views useful for illustrating the handover processing according to FIG. 11. Suppose that the measurement report includes the reception quality information of the reserve candidate cell 4c of the 1^{st} reception quality and the reserve candidate cell 4d of the 2^{nd} reception quality. If the possibility of occurrence of RLF in the reserve candidate cell 4c of the 1^{st} reception quality is within the prescribed reference, the handover preparatory procedure is executed to cells 4b and 4c, as illustrated in FIG. 12A. If the possibility of occurrence of RLF in the reserve candidate cell 4c of the 1^{st} reception quality exceeds the prescribed reference, the handover preparatory procedure is executed to cells 4b, 4c and 4d, as illustrated in FIG. 12B.

FIG. 12A and FIG. 12B depict the case where the measurement report includes the reception quality information of two reserve candidate cells 4. However, the reception quality information of more than two reserve candidate cells 4 may be included in the measurement report. For example, suppose that the measurement report includes the reception quality information of m reserve candidate cells 4, and that the possibility of occurrence of RLF of the reserve candidate cell 4 of the n^{th} reception quality is within the prescribed reference (n≦m), and that the possibility of occurrence of RLF of the reserve candidate cells 4 of the 1^{st} to (n−1)^{th} reception quality exceeds the prescribed reference. In this case, the handover preparatory procedure is executed to the reserve candidate cells 4c of 1^{st} to i^{th} reception quality.

In accordance with this embodiment, if no cell 4 which has the possibility of occurrence of RLF within the prescribed reference is found, the number of reserve candidate cells to which the handover preparatory procedure is executed can be increased. Therefore, possibility of success of reconnection procedure is increased. In this embodiment, if a cell 4 with the possibility of occurrence of RLF within the prescribed reference is found, the number of reserve candidate cells to which the handover preparatory procedure is executed is not increased. Therefore, unnecessary increase of the number of cells to which the handover preparatory procedure is executed can be prevented, and transmission of control signal between base stations can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A base station apparatus comprising:
a reception unit which receives cell information designating a plurality of cells for which reception quality at a mobile station apparatus connected to a serving cell covered by the base station apparatus exceeds a quality;
a failure prediction unit which predicts the possibility of occurrence of radio link failure in any of the plurality of cells designated by said cell information; and
an execution unit which executes, based on the prediction result of said failure prediction unit, a preparatory procedure with other base station apparatuses respectively covering the plurality of cells designated by said cell information for handover of said mobile station apparatus, when the possibility of occurrence of radio link failure exceeds a reference.

2. The base station apparatus as claimed in claim 1, wherein said preparatory procedure includes transmission of information which makes handover possible by said mobile station apparatus.

3. The base station apparatus as claimed in claim 2, wherein said information which makes handover possible is key information corresponding to a secret key of the base station.

4. The base station apparatus as claimed in claim 1, wherein said failure prediction unit predicts possibility of occurrence of radio link failure based on the frequency of radio link failure having occurred in said any of cells.

5. The base station apparatus as claimed in claim 4, further comprising:
a reconnection request processing unit which executes processing in response to a reconnection request in which a mobile station apparatus experiencing radio link failure requests connection to a cell covered by said base station apparatus; and
a failure indication signal transmission unit which transmits radio link failure indication signal to the base station apparatus covering the cell in which a mobile station apparatus experiencing radio link failure to inform that a reconnection request was received from this mobile station apparatus;
wherein said failure prediction unit predicts possibility of occurrence of radio link failure based on the frequency of transmission of the radio link failure indication signal transmitted in response to the reconnection request in which a mobile station apparatus experiencing radio link failure in said any of cells requests connection to said serving cell.

6. The base station apparatus as claimed in claim 4, further comprising a reconnection request processing unit which executes processing in response to a reconnection request in which a mobile station apparatus experiencing radio link failure requests connection to a cell covered by said base station apparatus;
wherein said failure prediction unit predicts possibility of occurrence of radio link failure based on frequency of occurrence of reconnection request in which a mobile station apparatus experiencing radio link failure in said any of cells requests connection to said serving cell.

7. The base station apparatus as claimed in claim 1, wherein said transmission unit transmits said key information to another base station apparatus covering a cell different from said any of cells in which possibility of occurrence of radio link failure exceeds said reference among the plurality of cells designated by said cell information.

8. The base station apparatus as claimed in claim 1, wherein said cell information is a measurement report which reports measurement result of reception quality of signal from cells received by said mobile station apparatus, and includes reception quality information of a first cell and reception quality information of a second cell other than said first cell as information designating said first cell and said second cell; and
wherein said base station apparatus comprises a handover determination unit which determines, based on the reception quality information of said first cell, whether or not said mobile station apparatus is to be subjected to handover to said first cell; and wherein said transmission unit transmits said key information to another base station covering said second cell when possibility of occurrence of radio link failure in said first cell exceeds said reference.

9. The base station apparatus as claimed in claim 8, wherein, when possibility of occurrence of radio link failure in said first cell does not exceed said reference, said key information is transmitted only to another base station covering said first cell.

10. A communication system including a base station apparatus and a mobile station apparatus, said mobile station apparatus comprising:
a reception quality measurement unit which measures reception quality of signal from cells; and
a cell information transmission unit which transmits cell information designating a plurality of cells with measured reception quality exceeding a quality to the base station covering the serving cell of the mobile station apparatus; and
said base station apparatus comprising:
a reception unit which receives said cell information from the mobile station apparatus connected to the cell covered by the base station apparatus;
a failure prediction unit which predicts the possibility of occurrence of radio link failure in any of the plurality of cells designated by said cell information; and
an execution unit which executes, based on the prediction result of said failure prediction unit, a preparatory procedure with other base station apparatuses respectively covering the plurality of cells designated by said cell information for handover of said mobile station apparatus, when the possibility of occurrence of radio link failure exceeds a reference.

11. The communication system as claimed in claim 10, wherein said base station apparatus further comprises a condition notifying unit which notifies, to said mobile station apparatus, said quality and determination condition for determining whether or not said cell information is to be transmitted depending on whether or not reception quality of signal from a cell of said mobile station apparatus exceeds a value;
wherein, when reception quality of signal from a first cell satisfies said determination condition, said cell information transmission unit transmits reception quality information of the first cell and reception quality information of a second cell for which reception quality exceeds said quality other than said first cell, as said cell information.

12. A communication method comprising:
measuring reception quality of signal from a cell other than a serving cell received by a mobile station apparatus;
specifying a plurality of cells for which measured reception quality exceeds a quality;
predicting possibility of occurrence of radio link failure in any of specified plurality of cells; and
executing a preparatory procedure with other base station apparatuses respectively covering the plurality of cells for handover of said mobile station apparatus from said serving cell, when the possibility of occurrence of radio link failure exceeds a reference.

13. The communication method as claimed in claim 12, further comprising:
determining, based on said measured reception quality, whether or not said mobile station apparatus is to be subjected to handover to a first cell among said plurality of cells;
predicting possibility of occurrence of radio link failure in said first cell; and
executing a preparatory procedure with another base station apparatus covering a second cell among said plurality of cells for handover of said mobile station apparatus, when the possibility of occurrence of radio link failure in said first cell exceeds said reference.
